(19) United States
(12) Patent Application Publication
(10) Pub. No.: US 2008/0141624 A1
(43) Pub. Date: Jun. 19, 2008

(54) Layered Web Sealing and Severing Head and Method for Use Thereof

(75) Inventor: Stefan Tobolka, Caledon (CA)

Correspondence Address: SMART AND BIGGAR, 438 UNIVERSITY AVENUE, SUITE 1500 BOX 111, TORONTO, ON, M5G2K8, omitted

(73) Assignee: L3 CONTAINER CORPORATION, Caledon (CA)

(21) Appl. No.: 10/597,598

(22) PCT Filed: Feb. 3, 2005
(86) PCT No.: PCT/CA2005/000127

§ 371 Date: Aug. 1, 2006

Related U.S. Application Data
(63) Continuation of application No. 10/770,578, filed on Feb. 4, 2004, now abandoned.

(51) Int. Cl. B65B 7/00; B29C 65/00

(52) U.S. Cl. 53/374.4; 156/515; 156/251

(57) ABSTRACT

A sealing assembly is employed to clamp together layers of a layered web, such as two layers of flexible laminate plastic film, and to bond and cut the layers by applying heat and pressure. The sealing assembly may include a pair of jaws, one of which has a sealing head with a conductive knife protruding from a tapered dielectric supporting base. The knife has a high thermal conductivity relative to the supporting base. A current supplied through the knife heats it and the heat of the knife raises the temperature of the supporting base to a baseline temperature. When the head abuts the layered web, a spike current through the knife raises its temperature momentarily to melt through, and therefore sever, the web.

### BACKGROUND OF INVENTION

1. Field of Invention

This invention relates to a head for sealing and severing two or more layers of a web and has application in sealing across a tube of thermoplastic film or other materials and separating the tube at the seal in order to form a series of containers.

2. Description of the Related Art

Sealing machines are used to package fluids, such as granular materials or liquids of various viscosities, from water to syrup in pouches. One type of package or pouch-making machine is a vertical form, fill and seal machine. With vertical form, fill, and seal machines, a heat sealable web material may be supplied from a roll. The flat web material may be unwound and formed into a vertically oriented tube which surrounds a fluid delivery device, such as a spigot. A sealing assembly may be located below the delivery device, sealing across the tube by heat pressing the two layers of web materials together through the use of a sealing head reciprocating toward and away from the tube opposite a backstop. Initially, a bottom seal may be made and a quantity of flowable material delivered to the tube. The tube may then be indexed downwardly, and another seal made above the bottom seal so as to form a pouch between the two seals. The second seal will also act as a first seal for the next-to-be formed pouch. Subsequent to the forming of a pouch, the pouch may be separated from the web by a knife.

FIG. 1 illustrates an exemplary vertical form, fill, and seal machine 100, in which a flat web 112 of film is unwound from a roll 110 and sealed into a tube 114 surrounding a spigot 116 by a sealing head 118. The spigot is used to deliver a fluid to the tube and a sealing jaw assembly 122 may then be used to seal and cut filled pouches 120 from the tube 114. The filled pouches may be discharged from the machine onto a conveyor belt 130. The film of the web may be made of a heat sealable flexible, light-weight material, such as a polyethylene/polypropylene laminate or other similar plastic materials. The speed of machine 100 may be increased if, rather than metering out a suitable volume of fluid for each pouch before the upper seal to complete the pouch is formed, the tube 114 is filled above the level where the upper seal will be formed. A sealing device that forms a seal through a liquid-containing tube is disclosed in U.S. Pat. No. 6,178,724 to Tobolka.

In U.S. Pat. No. 6,178,724 to Tobolka the sealing jaw assembly comprises a sealing jaw with sealing heads and a backstop jaw that incorporates a knife which reciprocates between the heads.

Where a knife reciprocates between the sealing heads, the seals formed by the heads will be longitudinally spaced by an amount sufficient to accommodate the knife. For machines forming liquid filled pouches, this longitudinal space between the seals may trap liquid. A small amount of fluid trapped in this space will likely be converted to steam during the heat sealing operation, which may interfere with the proper formation of the seals. Furthermore, liquid trapped in this space might remain trapped even after severing of the web. Should this occur, the liquid, not being properly sealed in, may spoil; this is of particular concern if the liquid is intended for human consumption.

To avoid the noted drawbacks, the heads may simply seal pouches, and each pouch may be advanced in order to be separated at a cutting station downstream of the sealing heads. However, this approach has the drawback that care must be taken to ensure the seal between pouches is cut mid-way, so that the seal will be just as wide, and therefore just as secure, for the pouch below and above the cut.

Therefore, there remains a need for a rapid sealing assembly that will minimize a space between seals of adjacent containers.

### SUMMARY OF THE INVENTION

A sealing head for sealing and severing a layered web has a knife and a supporting base. The supporting base extends, in the lengthwise direction of the knife, along opposite faces of the knife to partially envelop it so that the strip is immobily held by the supporting base and protrudes from the base. The supporting base has a lower thermal conductivity than that of the strip. The sealing head may be used on a sealing jaw assembly, as for example, the sealing jaw assembly of a vertical form, fill, and seal machine. In use, the sealing head may be heated in order to, after a time, establish a baseline temperature in the supporting base which is sufficient to seal layers of the web together. The head may then be pressed against the web and the temperature of the knife momentarily spiked so that the web is severed by melting.

According to one aspect of this invention, there is provided a layered web sealing and severing head, comprising: a knife having a first thermal conductivity; a supporting base having a second, lower, thermal conductivity; said supporting base extending, in a lengthwise direction of said knife, along opposite faces of said knife so as to partially envelop said knife such that said knife is immobily supported by said supporting base and protrudes from said supporting base.

According to another aspect of the present invention, there is provided a sealing jaw assembly, comprising: a first jaw with a backstop; an opposed second jaw with a sealing head, said sealing head having: a strip having a first thermal conductivity; a supporting base extending along opposite faces of said strip so as to partially envelop said strip such that said strip is immobily supported by said supporting base and protrudes from said supporting base toward said backstop; said supporting base having a second, lower, thermal conductivity.

According to a further aspect of the present invention, there is provided a method of sealing and cutting a layered web, comprising: heating a sealing head comprising a knife having a first thermal conductivity protruding from a supporting base having a second, lower, thermal conductivity, to a baseline temperature, said baseline temperature sufficient to seal layers of said web together; pressing said sealing head against said web; and spiking a temperature of said knife above said baseline temperature so as to sever said web by melting.

Other features and advantages of the invention will become apparent from a review of the following description in conjunction with the figures.

### BRIEF DESCRIPTION OF THE DRAWINGS

In the figures which disclose example embodiments of the invention:

FIG. 1 is a perspective view of a conventional vertical form, fill and seal machine discharging onto a conveyor belt a succession of sealed pouches.

FIG. 2 is a top view of a sealing assembly made in accordance with an embodiment of the invention.

FIG. 3 is the front view of a portion of the sealing assembly of FIG. 2.

FIG. 4 is a perspective view of a sealing head and a schematic view of a heating control circuit for the head.

FIG. 5 is a schematic end view of the sealing head of FIG. 4.

FIG. 6 is a side view of the knife of the sealing head.

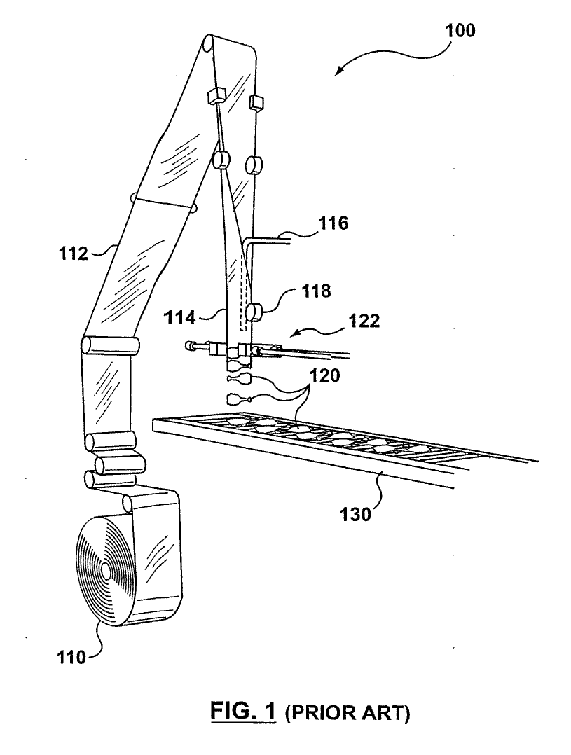

### DETAILED DESCRIPTION

A sealing assembly is employed to clamp together layers of a layered web, such as two layers of flexible laminate plastic film, and to bond and cut the layers by applying heat and pressure. In one embodiment of the invention, the sealing assembly includes a pair of jaws, one of which has a sealing head with a conductive knife protruding from a tapered dielectric supporting base. The knife has a high thermal conductivity relative to the supporting base. A current supplied through the knife heats it and the heat of the knife raises the temperature of the supporting base to a baseline temperature. When the head abuts the layered web, a spike current through the knife raises its temperature momentarily to melt through, and therefore sever, the web.

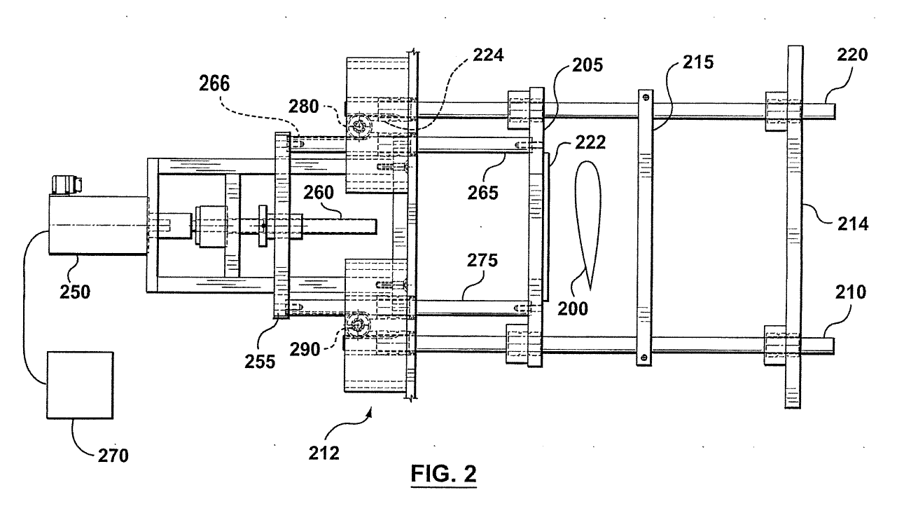

Turning to FIG. 2, plate 255 of an upper sealing assembly is joined to push rods 265, 275. A rack 266 extends from an end of each push rod, which end is joined to the plate 255. Similarly, a rack 222 extends from the end of each of shafts 210, 220, which end is proximate plate 255. Frame 212 supports two pinions 280, 290; each pinion meshes with both a rack 266 of one of the push rods 265 or 275 and a rack 224 of one of the shafts 210 or 220. When a motor 250 rotates a ball screw 260, plate 255 is advanced toward frame 212. The advancing plate 255 pushes the push rods 265, 275 to advance jaw 205, which is bearing mounted on shafts 210, 220, toward a tube film 200 and a jaw 215. Advancement of the push rods causes the rack of each push rod to rotate the pinion that meshes with it (in a counterclockwise sense). Because each rotating pinion also meshes with a rack 224 of a shaft 210, 220, the pinion pulls each shaft 210, 220. Since jaw 215 is joined to shafts 210, 220, the result is that the jaw 215, which is also bearing mounted on shafts 210, 220, is pulled toward the tube and jaw 205. The stationary frame members 212 and 214 anchor the various moving assemblies of reciprocating upper jaws 205 and 215.

The jaw 215 has a sealing head 222. The jaw 215 acts as a back stop for sealing head 222 and may, for example, be fabricated of a high density plastic material. Although not show, the mechanism for reciprocating the jaws is repeated with a lower assembly.

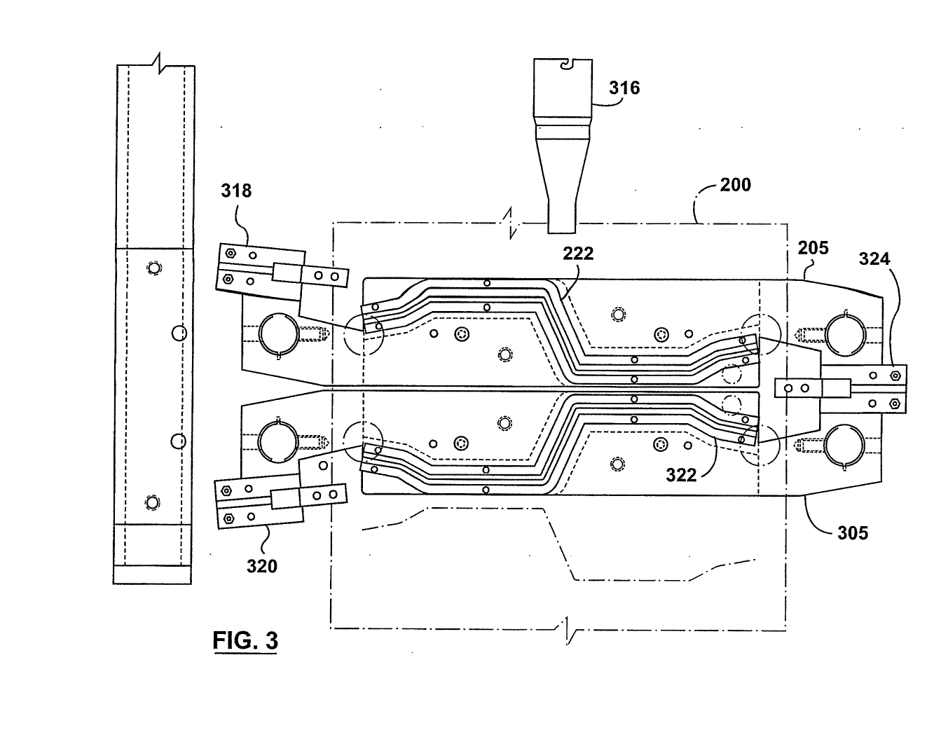

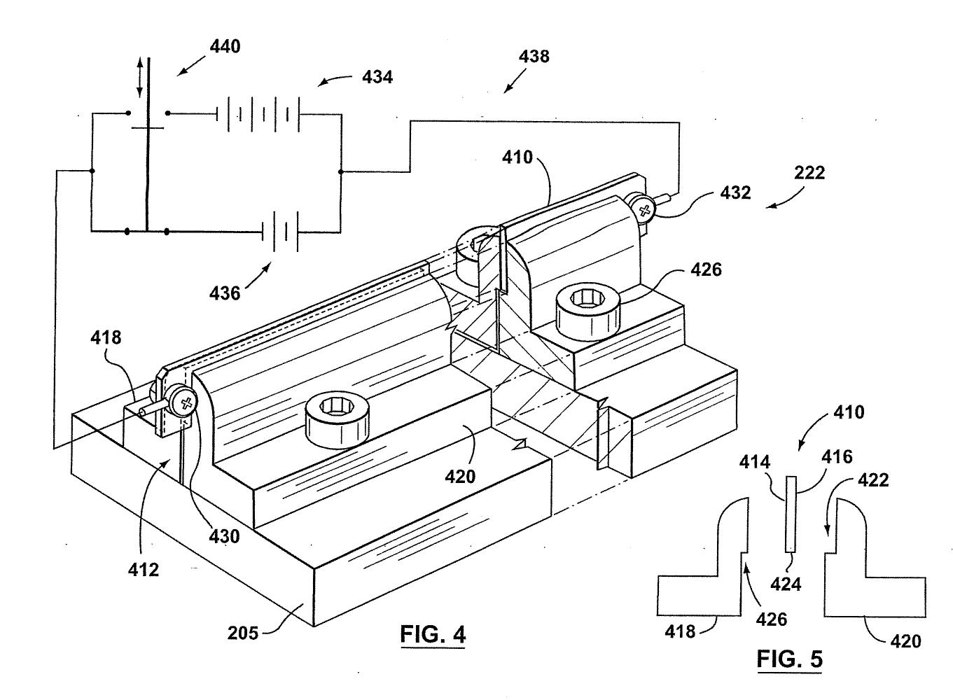

Turning to FIG. 3, jaw 205, with its sealing head 222 is seen in front view, along with a jaw 305, and its sealing head 322 of a lower sealing assembly. A fluid delivery spigot 316 is shown here for delivering flowable material into the film tube 200. Gripping fingers 318, 320, 324 may be provided to tension the tube 200. The sealing head 222 of jaw 205 is detailed in FIGS. 4 and 5. The sealing head 322 of jaw 305 is identically configured.

Turning to FIGS. 4 and 5, sealing head 222 comprises a knife 410, which is in the nature of a strip and a supporting base 412 extending along opposite faces 414, 416 of the strip such that the strip is partially enveloped, and immobily held, by the supporting base and protrudes from the supporting base. The strip may protrude about ten thousands of an inch (0.25 mm) from the supporting base. (The extent of the protrusion has been exaggerated in the figures for clarity.) It will be apparent from FIGS. 4 and 5 that the supporting base tapers toward the point where the strip protrudes from the supporting base. The supporting base has two halves 418, 420. Half 420 has a ledge 422 to abut the inner edge 424 of strip 410 and half 418 has a notch 426 to receive ledge 422 so that half 418 may be advanced toward half 420 sufficiently so that the strip 410 is sandwiched firmly between the halves. The halves of the support base may be bolted to jaw 205 by bolts 426.

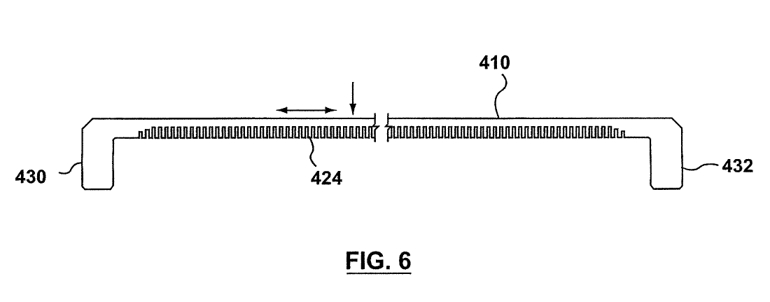

As seen in FIG. 6, the inner edge of strip 410 may have a series of notches. A terminal 430, 432 may be formed at either end of the strip 410. Returning to FIG. 4, it will be seen that the terminals may be coupled to electrical wires to complete an electrical circuit generally indicated at 438. The circuit may incorporate a larger electromotive force, battery 434, and a parallel smaller electromotive force, battery 436. One or other of the batteries may be coupled into the circuit by switch 440. The default position of switch 440 switches the smaller battery 436 into the circuit. The switch may be provided by a solid state relay.

The strip 410 is fabricated of a material that has a higher thermal conductivity than the material of which the supporting base 412 is fabricated. Furthermore, the strip is an electrical conductor, typically a metal such as steel, possibly doped to increase its resistivity, whereas the supporting base is a dielectric, such as anodised aluminum.

A processor 270 (FIG. 2) may control motor 250 (FIG. 2) and switch 440.

In operation, circuit 438 is completed and switch 440 left in its normal position to couple battery 436 into the circuit. This results in a current flowing through strip (knife) 410. As the strip has a resistivity, the current heats the strip. Over time, the heat from the strip heats the partially enveloping supporting base 412. The supporting base heats more slowly than the strip due to its lower thermal conductivity and the rate of this heat rise may be selected with the selection of its thermal conductivity. The processor 270 may maintain the sealing jaws 205, 215 idle for a time sufficient to allow the supporting base to attain a baseline temperature. The size of battery 436, and the resistivity of the strip 410, may be chosen so that the baseline temperature is sufficient to seal layers of tube 200 together. The processor may then control motor 250 to advance the jaws 205, 215 toward one another until they sandwich tube 200 between them. After a dwell time at a selected pressure, the heat of the strip and supporting base will form a seal across the tube. Thereafter, the processor momentarily switches switch 440 to couple the larger battery 434 into circuit 438. This spikes the current through strip 410 causing the temperature of the strip to spike. The size of battery 434 is chosen so that the spike temperature is sufficient to melt through and sever the tube 200 in a short period of time—e.g., 0.01 to 0.02 seconds. After this short period, the processor switches switch 440 back again, reducing the current in the strip, and thereby allowing it to cool back toward the baseline temperature. With a sufficient difference between the relatively high thermal conductivity of the strip as compared with the supporting base, the strip will heat and cool relatively rapidly with little change in the temperature of the supporting base. In consequence, the temperature of the supporting base may be controlled to remain well below a temperature which would melt through the tube. With the tube severed, the jaws may withdraw, the tube may be indexed downwardly, and the process repeated.

The notches in the inner surface of the knife allow the width of the knife to be increased so that it may be held more securely by supporting base 412 without providing a current path along the strip which is deep with the support. Such a deep current path along the strip could heat the supporting base more rapidly than is desirable.

Due to the taper of the supporting base 412, the pressure applied by the supporting base to the tube drops rapidly with distance from strip 410. The reduced pressure results in lesser heat transfer to the tube. The consequence is that the tube is sealed along a selectably narrow band, dependent upon the degree of the taper and the dwell time.

Rather than forming supporting base 412 of two halves and sandwiching the strip 410 between these halves, the supporting base may be molded so as to partially embed the strip in the supporting base. In such case, the supporting base may be conveniently fabricated of ceramic.

Rather than employing two batteries and a controllable switch to heat strip 410, any other controllable current source may be employed. This current source may generate direct current or alternating current.

Instead of heating strip 410 by passing current through the strip, the strip may be heated directly by a heater. In such case, the strip need not be electrically conductive, it would only be required that it have thermal conductivity higher than that of the supporting base.

While the knife has been shown as a plate-like strip, the knife could have other configurations. For example, the knife could be wedge-shaped.

While the head 222 has been described as used on a jaw of a vertical form, fill, and seal machine, the head has application in any situation where it is desired to seal and sever a layered web.

Other advantages and modifications within the scope of the invention will be apparent to those skilled in the art and, therefore, the invention is defined in the claims.

1. A layered web sealing and severing head, comprising:
a knife having a first thermal conductivity;
a supporting base having a second, lower, thermal conductivity;
said supporting base extending, in a lengthwise direction of said knife, along opposite faces of said knife so as to partially envelop said knife such that said knife is immobily supported by said supporting base and protrudes from said supporting base.

2. The head of claim 1 wherein said knife is an electrical conductor and said supporting base is not an electrical conductor.

3. The head of claim 2 further comprising a terminal at either end of said knife.

4. The head of claim 3 further comprising at least one electromotive force for coupling to each said terminal for establishing a baseline current through said knife and a momentary spike current through said knife.

5. The head of claim 2 to further comprising at least one electromotive force for coupling to either end of said knife for establishing a baseline current through said knife and a momentary spike current through said knife.

6. The head of claim 1 further comprising means for maintaining said knife at a baseline temperature and for periodically, momentarily, heating said knife to a higher spike temperature such that said supporting base remains substantially at said baseline temperature.

7. (canceled)

8. The head of claim 1 wherein said knife is partially embedded in said supporting base.

9. The head of claim 1 wherein said supporting base comprises two base halves that sandwich said knife therebetween.

10. The head of claim 2 wherein said supporting base is fabricated of anodised aluminum and said knife if fabricated of metal.

11. The head of claim 2 wherein said supporting base is fabricated of ceramic.

12. The head of claim 1 wherein said supporting base tapers to a point where said knife protrudes from said supporting base.

13. The head of claim 1 wherein said knife is a strip.

14. A sealing jaw assembly, comprising:
a first jaw with a backstop;
an opposed second jaw with a sealing head, said sealing head having:
a strip having a first thermal conductivity;
a supporting base extending along opposite faces of said strip so as to partially envelop said strip such that said strip is immobily supported by said supporting base and protrudes from said supporting base toward said backstop;
said supporting base having a second, lower, thermal conductivity.

15. The sealing jaw assembly of claim 14 wherein said strip is an electrical conductor and said supporting base is not an electrical conductor.

16. The sealing jaw assembly of claim 15 further comprising at least one electromotive force for coupling to either end of said strip for establishing a baseline current through said strip and, when said strip abuts said backstop through a material to be sealed, a momentary spike current through said strip.

17. The sealing jaw assembly of claim 14 further comprising means for reciprocating said first jaw and said second jaw toward and away from each other.

18. The sealing jaw assembly of claim 14 wherein said supporting base tapers to a point where said strip protrudes from said supporting base.

19. A method of sealing and cutting a layered web, comprising:
heating a sealing head comprising a knife having a first thermal conductivity protruding from a supporting base having a second, lower, thermal conductivity, to a baseline temperature, said baseline temperature sufficient to seal layers of said web together;
pressing said sealing head against said web for a dwell time in order to form a seal; and
thereafter, spiking a temperature of said knife above said baseline temperature so as to sever said web by melting.

20. (canceled)

21. The method of claim 19 wherein said heating said sealing head to a baseline temperature comprises establishing a first electric current through said knife and wherein said spiking said temperature of said knife comprises temporarily establishing a second electric current through said knife, said second electric current being greater than said first electric current.

22. The method of claim 19 wherein said layered web is a laminate of at least two different materials and said baseline temperature is selected so as to be sufficient to seal said layered web but insufficient to cut through said layered web.
